(19) United States
(12) Patent Application Publication
(10) Pub. No.: US 2026/0329992 A1
(43) Pub. Date: Oct. 22, 2026

(54) Gesture Biometrics Authentication System for Touchless and Inclusive Identity Verification

(71) Applicant: Oladayo Ayokunle Luke, Campbell, CA (US)

(72) Inventor: Oladayo Ayokunle Luke, Campbell, CA (US)

(73) Assignee: Perdurable Group inc., Campbell, CA (US)

(21) Appl. No.: 19/646,650

(22) Filed: Apr. 14, 2026

Related U.S. Application Data
(63) Continuation-in-part of application No. 19/040,873, filed on Jan. 30, 2025.

(51) Int. Cl. G06F 21/32; G06F 3/01; G06V 10/80; G06V 10/82; G06V 40/10; G06V 40/20; G06V 40/60

(52) U.S. Cl. CPC G06F 21/32; G06F 3/017; G06V 10/803; G06V 10/82; G06V 40/10; G06V 40/28; G06V 40/67

(57) ABSTRACT

A system and method for touchless biometric authentication using camera-captured gesture input are disclosed. The invention enables secure user verification by analyzing personalized gesture signatures characterized by velocity, shape, rhythm, and directional cadence. Real-time gesture data is processed through landmark detection and transformed into spatiotemporal vectors. Quantitative assessment is performed using linear algebra techniques such as magnitude and angle computation and similarity metrics including Levenshtein distance. A machine learning model trained on user-specific gesture patterns validates authentication attempts while tolerating natural behavioral drift. The system operates in browser-native or mobile environments without specialized hardware and supports multimodal integration, on-device verification, and continuous presence detection. This method offers an accessible, privacy-respecting alternative to traditional biometrics, particularly for users unable to utilize fingerprint or facial recognition technologies.

### CROSS-REFERENCE TO RELATED APPLICATION

This application is a continuation-in-part of U.S. Non-Provisional patent application Ser. No. 19/040,873, filed on Jan. 30, 2025. The disclosure of the above-referenced application is hereby incorporated by reference in its entirety.

The present invention extends the foundational gesture recognition architecture described in the parent applications by introducing a secure, identity-focused biometric authentication system that uses user-specific gesture patterns as a touchless alternative to fingerprints or facial recognition. This novel biometric layer is designed to support inclusive authentication for users who cannot rely on conventional physiological biometrics.

### TECHNICAL FIELD

The present invention relates to the fields of human-computer interaction, biometric authentication, and computer security. More specifically, it pertains to systems and methods for touchless identity verification using gesture-based biometric signatures captured via standard camera devices. This technology enables inclusive, secure access control within digital environments and contributes to cybersecurity through privacy-aware, non-contact authentication protocols.

### DEFINITIONS

Behavioral drift refers to gradual variation in a user's gesture execution over time, quantified using deviation metrics derived from stored gesture profiles.

Threshold-matched scores refer to similarities in values exceeding a predefined acceptance threshold determined during system training.

In this context, a user-specific gesture profile refers to a data structure comprising feature vectors derived from previously authenticated gesture inputs, including spatial, temporal, and kinematic characteristics. The profile is updated over time based on confirmed user interactions to account for natural variation in gesture execution, a process referred to as behavioral drift adaptation.

### BACKGROUND

Biometric authentication systems such as fingerprint scanning, facial recognition, and iris detection have become widely adopted for secure user verification across digital platforms. These systems offer convenience and security benefits but rely on direct physical contact or high-resolution imaging hardware. For individuals with physical disabilities, facial uniqueness limitations, or privacy concerns, such technologies may be inaccessible or ineffective. Furthermore, conventional biometrics can be susceptible to spoofing attacks, require specialized sensors, and lack adaptability across diverse environments and user contexts.

Touchless gesture recognition technologies, on the other hand, have advanced significantly with the availability of real-time camera input and lightweight machine learning frameworks. Yet, most gesture systems focus on command execution or navigation not on secure, user-specific identity verification. There remains a critical gap in integrating gesture-based input as a biometric authentication method that is inclusive, contact-free, and compatible with mainstream computing devices.

This invention addresses these limitations by introducing a gesture biometrics system that recognizes unique, user-specific motion patterns as authentication credentials. It enables a secure and accessible alternative to traditional biometrics, suitable for diverse user populations and adaptable to a range of digital security contexts.

### PRIOR ART

Various gesture recognition systems and biometric technologies have been proposed for secure user authentication. Prior efforts in this domain have largely centered on touch-based interfaces, wearable sensor inputs, or specialized hardware such as depth cameras and infrared scanners. While some systems explore the use of gestures in authentication, they often combine them with conventional biometrics, rely on static hand poses, or require hardware configurations that limit accessibility and scalability.

US 2020/0128006 A1—Gesture-Based Signature Authentication: Details a system where gestures detected via IMU and imaging sensors on a mobile device are combined with conventional biometrics (like fingerprints) for authentication. It relies on specialized hardware and dual biometric modes.

U.S. Pat. No. 10,733,274 B2—Biometric Authentication Using Gesture: Details a system where gestures detected via IMU and imaging sensors on a mobile device are combined with conventional biometrics (like fingerprints) for authentication. It relies on specialized hardware and dual biometric modes.

US 2020/0128010 A1 (PH12021551836A1)—Non-Contact Palm Biometric Authentication: Focuses on using palm imagery through cameras for identity verification. It doesn't use dynamic gestures or behavioral analysis.

Research—3D Hand Gesture Signature Biometric (FMCode): A scholarly framework for in-air 3D-handwriting gesture biometric authentication. It uses accelerometer/motion data rather than camera-based gesture recognition.

Research—Gesture-Based Hand Sign Language Biometric: Proposes static hand-shape pattern recognition for biometric use via video. It lacks dynamic gestures, sequencing or personalization.

Despite advancements in gesture input and biometric verification, the reviewed prior art does not adequately provide a scalable, camera-only, touchless gesture authentication system that personalizes gesture patterns over time for identity verification. Existing approaches do not adequately support inclusive access, environmental adaptability, or behavioral learning from standard consumer-grade devices. This invention uniquely addresses these shortcomings, offering a standalone, privacy-conscious solution optimized for secure, hands-free authentication across mainstream web and mobile environments.

### UNFULFILLED NEED

Current biometric authentication technologies are largely inaccessible to users who cannot rely on fingerprints, facial recognition, or voice input due to physical, cultural, or contextual limitations. These systems often require specialized hardware, fixed lighting conditions, or static image capture, making them impractical for widespread or inclusive use. Additionally, most gesture-based systems are designed for command control rather than secure identity verification and lack the ability to personalize or adapt to individual users over time.

There remains a critical need for a secure, camera-based authentication solution that enables users to verify their identity using dynamic, personalized gesture patterns. Such a system must operate without physical contact, support real-time adaptability based on environmental and user-specific factors, and ensure privacy while being deployable across standard consumer devices. This invention addresses that need by offering a novel gesture biometrics framework tailored for inclusivity, security, and practical implementation in everyday digital applications.

### FAILURES OF OTHERS

Existing biometric authentication systems, including fingerprint scanners, facial recognition systems, and gesture-based interfaces, exhibit limitations in accessibility, hardware dependency, and environmental robustness. Many systems rely on specialized sensors or controlled conditions, reducing compatibility with standard consumer devices and limiting deployment across diverse user environments.

Gesture-based systems developed to date are primarily designed for user interface navigation rather than identity verification. Such systems often rely on static gesture recognition or predefined input patterns and do not incorporate user-specific behavioral modeling or adaptive learning. As a result, these approaches provide limited accuracy for authentication purposes and may be susceptible to spoofing or inconsistent performance across users.

### PROBLEMS WITH PRIOR ART

While prior art demonstrates progress in both gesture recognition and biometric authentication, it falls short in several critical areas necessary for inclusive, real-world deployment. First, many systems depend on specialized or proprietary sensors—such as infrared, IMUs, or depth cameras that limit scalability and affordability. Second, existing gesture-based authentication methods often rely on static hand shapes or require touch input, making them unsuitable for touchless or hands-free contexts.

Moreover, most gesture recognition platforms lack personalized biometric profiling, offering generic gesture interpretation rather than adaptive, user-specific authentication signatures. They also fail to dynamically adjust to environmental changes such as lighting variability or background noise, leading to unreliable performance. Privacy is another major concern, as some systems store biometric data without sufficient obfuscation or user control.

Crucially, few prior systems provide a purely camera-based, behavioral gesture authentication method that learns from user interaction over time while integrating with mainstream web and mobile applications. This invention addresses these gaps by introducing a privacy-conscious, adaptive, and accessible biometric authentication solution based on gesture behavior.

### SERIOUS NATURE OF THE PROBLEM

Secure and inclusive access to digital systems is a fundamental requirement in modern computing. However, a significant portion of the global population is excluded from conventional biometric authentication due to physical disabilities, cultural constraints, or lack of access to compatible hardware. This exclusion not only limits participation in digital ecosystems but also increases dependency on insecure or inconvenient alternatives like shared passwords or assistance from others compromising both privacy and autonomy.

The lack of accessible, touchless, and personalized authentication mechanisms also poses a cybersecurity risk, as users may be forced to rely on weaker or shared credentials. Furthermore, current systems inadequately protect individuals in environments where touch-based input is impractical or unsafe (e.g., sterile settings, public terminals, or during health crises). This absence of inclusive, secure, and adaptable authentication technologies creates a serious and growing divide that impacts digital trust, personal privacy, and equitable access to technology.

### SUMMARY OF THE INVENTION

The present invention provides a touchless biometric authentication system that leverages personalized gesture signatures as secure and inclusive identifiers. Using a consumer-grade camera, the system captures real-time hand or facial gesture input and extracts biometric features such as gesture shape, rhythm, velocity, and angular transitions. These features are processed through a combination of linear algebraic transformations and adaptive machine learning models to create and match gesture profiles uniquely associated with each user.

The invention includes an integrated architecture consisting of a camera interface, landmark detection engine, biometric feature extractor, and a signature matcher capable of measuring similarity using tools such as Levenshtein distance and vector-based angle matching. In some embodiments, spatial relationships include distances and angular relationships between finger joints, fingertip positions, and palm reference points. A flexible authentication engine evaluates input fidelity and adapts over time to user-specific behavior while compensating for drift.

The system supports secure user verification for applications such as login, digital signatures, session presence detection, and accessibility use cases. Unlike prior biometric systems tied to fingerprints or facial recognition, this approach accommodates users with diverse physical and privacy needs, offering a modular, privacy-conscious solution deployable in browser-native and mobile environments without specialized hardware. These features are provided as optional embodiments and are not required for operation of the core gesture-based authentication system.

### FUNCTIONAL BENEFITS

The proposed system delivers multiple functional advantages that address both security and accessibility concerns in digital identity verification. By enabling users to train gesture signatures linked to their identity, the system allows for a personalized and secure biometric alternative, particularly for individuals who cannot rely on fingerprints or facial recognition. Adaptive matching algorithms ensure robustness by tolerating natural variations in gesture performance while maintaining resistance to spoofing attempts.

The invention supports diverse use cases such as two-factor authentication, secure login, electronic signatures, and device unlocking without the need for physical contact or specialized hardware. Designed to work with standard cameras and browser-native environments, it ensures broad compatibility across the web and mobile platforms.

Behavioral drift is addressed through a retraining engine that periodically adjusts gesture models based on validated user behavior. The system captures biometric features such as gesture shape, velocity, and rhythm, enabling unique user identification. Additional features include privacy-conscious operation, support for users with visual or motor impairments, and continuous presence detection for session security. Gesture biometrics can also be combined with other factors such as facial recognition to enable multimodal, high-assurance authentication strategies.

### KEY INNOVATIVE ASPECTS

The Gesture Biometrics Authentication System for Touchless and Inclusive Identity Verification introduces several groundbreaking innovations that distinguish it from conventional biometric and gesture-recognition systems:

Personalized Gesture Signatures: Unlike static gesture libraries, the system generates dynamic, user-specific biometric profiles by analyzing gesture rhythm, shape, velocity, and cadence using linear algebra techniques. Gesture trajectories are encoded as spatiotemporal vectors, with magnitudes and directional angles computed from keypoint motion. These feature vectors are compared using similarity metrics such as Levenshtein distance and cosine alignment to assess authentication confidence. A flexible machine learning model further adapts to behavioral variations, learning each user's gesture patterns over time while maintaining security thresholds. This approach transforms natural, repeatable movement into a personalized and robust biometric authentication factor.

Behavioral Drift Compensation: A built-in retraining module continuously refines recognition accuracy by learning from validated interactions, ensuring long-term usability even as a user's motion profile evolves.

Privacy-Conscious Design: All data processing is compatible with on-device inference and browser-native technologies (e.g., TensorFlow.js), ensuring biometric data never needs to leave the user's device.

Environmental Adaptability: The system adjusts detection sensitivity based on ambient lighting, camera quality, and user context, maintaining accuracy across real-world settings.

Inclusive Access Control: It enables identity verification for users unable to use traditional biometrics (e.g., due to facial differences, finger deformities, or disability), supporting equitable digital access.

Touchless Multi-Factor Authentication: Integrates gesture recognition with other biometric or contextual factors (e.g., facial ID or environment cues) to strengthen authentication security.

Continuous Presence Detection: Beyond login, the system monitors passive gestures to lock or unlock sessions, offering seamless and secure session continuity.

Gesture-to-Authentication Use Cases: Extends beyond login to support electronic signatures, secure app access, and contextual approvals broadening gesture biometrics into enterprise, education, and healthcare domains.

Modular SDK/API Design: Designed for rapid integration into existing web/mobile environments via SDKs and APIs, empowering developers to deploy touchless authentication without hardware dependencies.

These innovations collectively establish a novel and inclusive approach to biometric authentication, pushing gesture-based security into practical, real-world deployment.

### BRIEF DESCRIPTION OF THE FIGURES

FIG. 1 is a block diagram illustrating the system architecture (100) for the Gesture Biometrics Authentication System for Touchless and Inclusive Identity Verification. It includes: (101) Input & Capture Layer featuring the Camera Input Interface (102) and Preprocessing Engine (104) for capturing and normalizing real-time gesture data. (103) Gesture Processing & Recognition Layer with the Landmark Detection Module (106), Biometric Feature Extractor (108), and Signature Matcher (110) for analyzing gesture-based biometric features. (105) Authentication & Security Layer consisting of the Authentication Engine (112) and Behavioral Drift Monitor (114) to securely verify identity and update gesture profiles over time. (107) Integration & Application Layer which includes the Application Gateway (116) and Multi-Factor Fusion Layer (118) for delivering secure access across digital systems. (109) Feedback & Adaptation Layer containing the Feedback Manager (122) and Personalization Trainer (124) to guide users and support adaptive learning.

The system interacts with External Biometric Sources (128) via the Multi-Factor Fusion Layer (118), which aggregates gesture biometrics with facial recognition or device signals before final verification in the Authentication Engine (112). Personalized gesture models evolve over time using feedback collected through the Behavioral Drift Monitor (114) and Personalization Trainer (124). These models are initially informed and periodically updated using data from the User (126) and are refined based on session-specific patterns.

### DETAILED DESCRIPTION OF FIGURES

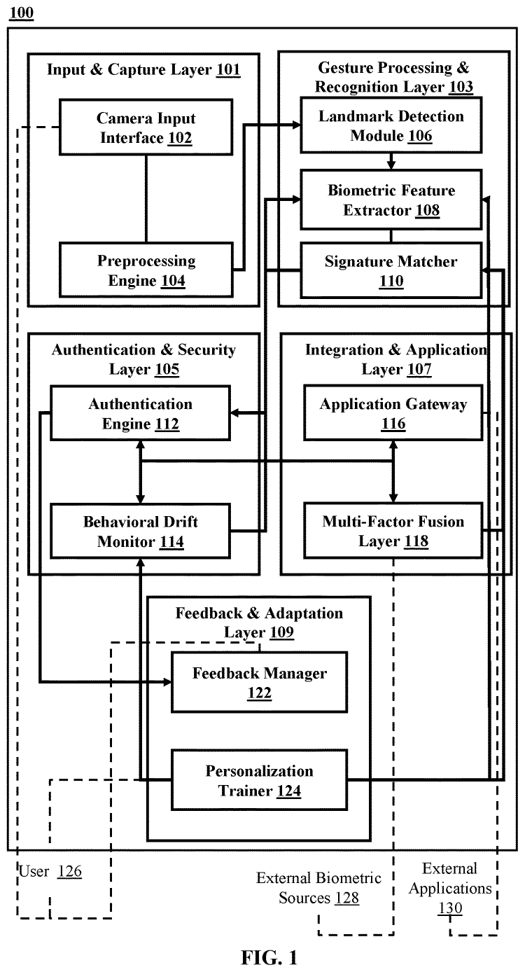

FIG. 1 illustrates the high-level system architecture (100) of the Gesture Biometrics Authentication System for Touchless and Inclusive Identity Verification. The architecture is divided into five primary groups, each representing a distinct functional layer in the authentication pipeline:

The Input & Capture Layer (101) starts with the Camera Input Interface (102), which collects real-time video data from a standard camera. This feed is immediately forwarded to the Preprocessing Engine (104), which filters and normalizes the input stream to reduce noise, correct lighting inconsistencies, and enhance gesture clarity. This preprocessing ensures that only high-quality visual data is sent downstream.

Next, in the Gesture Processing & Recognition Layer (103), the cleaned video is passed to the Landmark Detection Module (106), where lightweight machine learning models detect key gesture landmarks (e.g., fingertips, hand contours). The detected landmarks are then sent to the Biometric Feature Extractor (108), which computes gesture dynamics such as shape, rhythm, and velocity. These features are forwarded to the Signature Matcher (110), which compares them against stored gesture profiles to identify or verify the user. If no match is found, the matcher can trigger a retry signal or escalate to fallback methods.

The Authentication & Security Layer (105) receives matching results from the Signature Matcher. The Authentication Engine (112) confirms the match and manages authentication status, including fallback handling and secure token generation. It also feeds interaction history to the Behavioral Drift Monitor (114), which continuously evaluates and updates gesture profiles to reflect gradual changes in the user's biometric behavior. This interaction loop ensures long-term accuracy and user-specific adaptation.

The Integration & Application Layer (107) is responsible for connecting the system to external services. Once the Authentication Engine confirms identity, the Application Gateway (116) sends the authenticated status to login portals, secure app modules, or signature systems. Simultaneously, the Multi-Factor Fusion Layer (118) can enhance the authentication flow by integrating auxiliary biometric data, such as facial recognition, to create a hybrid identity verification protocol. This layer allows seamless integration without disrupting the user experience.

Furthermore, the Feedback & Adaptation Layer (109) closes the loop by supporting real-time interaction and training. The Feedback Manager (122) receives signals from the Authentication Engine to guide users with visual or auditory prompts (e.g., retry prompts, success indicators). Meanwhile, the Personalization Trainer (124) collaborates with the Feature Extractor and Behavioral Drift Monitor to help users train, adapt, and fine-tune their gesture profiles using reinforcement learning techniques.

The system is architected to not only authenticate users based on personalized gesture input but also enable rich interaction capabilities with external systems via gesture-command mapping. Internally, gesture patterns such as hand pinches, flicks, or directional swipes are classified and converted into interaction commands including left-click, right-click, double-click, mousedown, mouse release, scroll-up, and scroll-down. These gesture-to-command translations allow users to navigate, select, or interact with application interfaces in real-time without physical input devices. These commands are routed through the Application Gateway (116) and emitted to External Applications (130) denoted by dashed-line connections—where gesture-authenticated interactions drive form inputs, content navigation, or UI selections.

To support identity verification and multimodal authentication, the system interacts with External Biometric Sources (128) via the Multi-Factor Fusion Layer (118), which aggregates gesture biometrics with facial recognition or device signals before final verification in the Authentication Engine (112). Personalized gesture models evolve over time using feedback collected through the Behavioral Drift Monitor (114) and Personalization Trainer (124). These models are initially informed and periodically updated using data from the User (126) and are refined based on session-specific patterns.

The Session-Aware Profile Loader, implemented as part of the system's adaptation pipeline (within or adjacent to the Preprocessing or Landmark Detection stages), dynamically loads gesture thresholds, interaction mappings, and environmental parameters based on user identity and session context. This ensures that gesture interactions such as scrolls or clicks remain accurate and personalized even as task types, environments, or user behavior shift. Together, the system integrates gesture-based input, biometric verification, and context-aware profile management into a unified, extensible architecture that interacts with external services through well-defined modular boundaries.

Each component communicates with others through clearly defined input-output relationships, forming a cohesive and extensible system. This architecture ensures robust biometric gesture authentication, scalable deployment, and inclusive access across diverse environments.

### DETAILED DESCRIPTION OF THE INVENTION

The present invention introduces a gesture-based biometric authentication system that enables secure, inclusive, and touchless identity verification using personalized in-air gesture patterns. It leverages standard cameras, lightweight machine learning, and modular software components to offer a practical alternative to traditional biometric methods like fingerprint and facial recognition, particularly benefiting users who face physical, cultural, or privacy limitations.

The system architecture comprises multiple interrelated layers:
(1) Input & Capture Layer: A standard webcam or mobile camera captures real-time hand or facial gesture data. The Camera Input Interface (102) initiates this process and passes the video feed to the Preprocessing Engine (104), which cleans and normalizes the input by adjusting for lighting, occlusion, and motion blur. This ensures high-quality data for gesture interpretation.
(2) Gesture Processing & Recognition Layer: The cleaned video frames are processed by the Landmark Detection Module (106), which extracts key hand/facial points using lightweight models (e.g., TensorFlow.js, MediaPipe). In the biometric authentication process, the system conducts a quantitative assessment of gesture fidelity using linear algebra techniques. The Biometric Feature Extractor (108) computes vector magnitudes based on Euclidean distances between gesture keypoints and evaluates directional transitions using dot product-derived angle calculations. These spatial and temporal measurements are converted into feature vectors that represent the dynamic characteristics of the user's gesture. These vectors are then analyzed by the Signature Matcher (110), which uses similarity metrics such as Levenshtein distance for sequence alignment and angular displacement for directional accuracy. The matcher is backed by a machine learning model designed to tolerate intra-user variability while rejecting anomalies and spoofed inputs. This model remains flexible, continuously adapting to subtle behavioral shifts over time through feedback from verified sessions, thereby ensuring robust and personalized gesture-based biometric authentication.
(3) Authentication & Security Layer: The Authentication Engine (112) verifies the user's identity based on matching scores and triggers access or fallback responses accordingly. The Behavioral Drift Monitor (114) monitors long-term usage and initiates retraining if deviation in gesture performance exceeds a defined threshold. This loop ensures continued accuracy and personalization.
(4) Integration & Application Layer: Once authentication is successful, the Application Gateway (116) securely transmits this result to external apps for login, document signing, or device unlocking. The Multi-Factor Fusion Layer (118) optionally integrates secondary authentication signals like face ID or contextual triggers to enhance security in sensitive use cases.
(5) Feedback & Adaptation Layer: To ensure usability, the Feedback Manager (122) displays on-screen cues—success, retry, or error messages—based on gesture execution results. The Personalization Trainer (124) guides users through onboarding and gesture training using reinforcement learning, helping the system learn individual motion dynamics over time.

This architecture delivers an inclusive, scalable, and privacy-conscious authentication method that can be easily integrated into existing web or mobile platforms using SDKs or APIs. It addresses critical gaps in usability, accessibility, and cultural adaptability representing an advancement in biometric authentication systems.

### Conclusion

The Gesture Biometrics Authentication System for Touchless and Inclusive Identity Verification presents a novel, privacy-conscious, and user-adaptive approach to biometric authentication. By leveraging camera-captured gesture signatures, the invention empowers secure and inclusive access for users traditionally underserved by existing biometric modalities. Its modular architecture spanning gesture capture, recognition, personalization, and secure integration ensures seamless deployment across diverse web, mobile, and enterprise environments.

The system addresses key limitations in prior art by introducing behavioral drift compensation, multi-factor authentication capabilities, and gesture-to-biometric transformation using lightweight, privacy-preserving models. It provides a reliable authentication alternative for users who cannot use face or fingerprint recognition and adapts dynamically to environmental and user-specific variables.

By enabling identity verification through intuitive, personalized gestures, this invention strengthens cybersecurity while broadening digital inclusion. It lays a foundation for future gesture-based interfaces that combine accessibility, usability, and security in a single, user-centric platform.

1. A computer-implemented system for touchless biometric authentication using personalized gesture input, comprising: a camera input module configured to capture real-time gesture data; a preprocessing engine configured to normalize gesture input to handle variations in lighting, motion, or background; a landmark detection module configured to extract hand or facial keypoints from video input; a biometric feature extractor configured to derive gesture-based biometric data comprising velocity, rhythm, shape, and directional transitions using mathematical transformations comprising vector magnitude and directional angle computations derived from spatial relationships between gesture landmarks; a signature matcher configured to perform quantitative assessment of gesture similarity using metrics comprising Levenshtein distance and angle-based vector comparisons; an authentication engine configured to determine identity validity and initiate secure access protocols; and a verification module configured to generate an authentication result based on threshold-matched scores from the quantitative assessment and stored user-specific gesture profiles comprising feature vectors derived from prior authenticated gesture inputs and updated over time to reflect behavioral variation.

2. The system of claim 1, wherein the gesture biometric is defined by user-specific patterns comprising stroke direction, gesture timing, and dynamic motion profiles.

3. The system of claim 1, wherein the signature matcher incorporates machine learning to compensate for behavioral drift across repeated uses.

4. The system of claim 1, further comprising a feedback module configured to provide visual or auditory prompts to guide gesture input and confirm authentication results.

5. The system of claim 1, further comprising a personalization trainer configured to facilitate user onboarding, retraining, and gesture profile updates using reinforcement learning.

6. The system of claim 1, wherein the authentication engine is configured to integrate with external applications for secure login, electronic signatures, or device unlocking.

7. The system of claim 1, wherein the biometric authentication operates entirely on-device using browser-native or mobile-native machine learning frameworks.

8. The system of claim 1, wherein the biometric feature extractor is configured to support multimodal fusion by combining gesture data with at least one secondary biometric input.

9. The system of claim 1, wherein continuous gesture monitoring is used to detect user presence and trigger session lock or unlock events.

10. The system of claim 1, wherein the biometric feature extractor dynamically adjusts gesture interpretation thresholds based on environmental conditions.

11. The system of claim 1, wherein the signature matcher performs quantitative assessment using vector magnitude and directional angle analysis derived from landmark data.

12. The system of claim 1, wherein the authentication engine is configured to perform multimodal authentication by combining gesture biometrics with contextual inputs.

13. The system of claim 1, wherein gesture authentication includes time-weighted scoring to detect deviations in gesture performance.

14. The system of claim 1, wherein a machine learning model adapts over time using confirmed user interactions to enable behaviorally personalized authentication profiles.

15. The system of claim 1, wherein gesture profile templates are encrypted and stored locally to preserve user privacy during offline authentication.

16. The system of claim 1, wherein the personalization trainer applies reinforcement learning to adapt gesture-based authentication profiles based on user-confirmed success or error correction events.

17. The system of claim 1, wherein the gesture authentication interface includes accessibility features comprising simplified gesture sets, auditory feedback, or enlarged interaction zones.

18. A computer-implemented method for authenticating a user using gesture biometrics, comprising: capturing gesture input via a consumer-grade camera; preprocessing the input to enhance clarity and reduce environmental noise; extracting landmarks and computing biometric features of the gesture; comparing the computed features to a stored user-specific gesture profile comprising feature vectors derived from prior authenticated gesture inputs; generating an authentication decision based on the comparison score; and integrating the authentication decision with downstream application logic.

19. The method of claim 18, further comprising adapting the stored user profile over time to account for user-specific gesture variations and behavioral drift.

20. The method of claim 18, wherein gesture biometric authentication is deployed within a plugin interface or software development kit integrated into web or mobile platforms.
